(19) United States
(12) Patent Application Publication
(10) Pub. No.: US 2016/0342017 A1
(43) Pub. Date: Nov. 24, 2016

(54) DISPLAY DEVICE

(71) Applicant: SAMSUNG DISPLAY CO., LTD., Yongin-si (KR)

(72) Inventors: Seiyong PARK, Hwaseong-si (KR); Jungwook LEE, Anyang-si (KR); Hyoungcheol LEE, Suwon-si (KR); Changil TAE, Seoul (KR)

(21) Appl. No.: 15/065,033

(22) Filed: Mar. 9, 2016

(30) Foreign Application Priority Data
May 18, 2015 (KR) 10-2015-0068885

(51) Int. Cl. G02F 1/1335; G02F 1/1343; G02F 1/1333; G02F 1/1362; G02F 1/1368

(52) U.S. Cl. CPC G02F 1/133514; G02F 1/136286; G02F 1/1368; G02F 1/133345; G02F 1/133512; G02F 1/134309; G02F 1/13624; G02F 2201/50; G02F 2001/134345

(57) ABSTRACT

A display device includes: a first substrate; a gate line and a data line on the first substrate; a transistor connected to the gate line and the data line; an insulating layer on the data line and the transistor; and a color filter layer on the insulating layer. The color filter layer may include a first support pattern portion extending substantially parallel to the gate line.

### CROSS-REFERENCE TO RELATED APPLICATION

This application claims priority to and the benefit of Korean Patent Application No. 10-2015-0068885, filed on May 18, 2015, with the Korean Intellectual Property Office, the disclosure of which is incorporated herein in its entirety by reference.

### BACKGROUND

1. Field

Embodiments of the present invention relate to a display device capable of preventing detachment of a color filter layer in a process of light exposure and development performed to form the color filter layer.

2. Description of the Related Art

Display devices are classified into liquid crystal display (“LCD”) devices, organic light emitting diode (“OLED”) display devices, plasma display panel (“PDP”) devices, electrophoretic display (“EPD”) devices, and the like, based on a light emitting scheme thereof.

The LCD device includes two substrates opposing each other and a liquid crystal layer interposed between the two substrates. Further, a thin film transistor, a pixel electrode, and the like are disposed on one of the two substrates opposing each other. Herein, the thin film transistor and the pixel electrode are connected to each other through a contact hole extending therethrough from above to below.

Recently, LCD devices having a high resolution are released, and along with such trend, researches on LCD devices having a high definition are being conducted in earnest. In general, LCD devices have a high resolution, as a pixel area constituting the LCD device increases. That is, a non-display formed on a substrate should be significantly reduced at maximum.

Accordingly, it is necessary to reduce the size of a contact hole defined in a non-pixel area. To this end, disposition of a color filter layer formed on a lower substrate is crucial. Further, it is also important to prevent detachment of the color filter in a process of forming the color filter.

It is to be understood that this background of the technology section is intended to provide useful background for understanding the technology and as such disclosed herein, the technology background section may include ideas, concepts or recognitions that were not part of what was known or appreciated by those skilled in the pertinent art prior to a corresponding effective filing date of subject matter disclosed herein.

### SUMMARY

Aspects of embodiments of the present invention are directed to a display device including a first support pattern portion capable of supporting a red color filter, a green color filter, and a blue color filter, which constitute a color filter layer, to be connected to each other.

According to one exemplary embodiment of the present invention, a display device includes: a first substrate; a gate line and a data line on the first substrate; a transistor connected to the gate line and the data line; an insulating layer on the data line and the transistor; and a color filter layer on the insulating layer. The color filter layer may include a first support pattern portion extending substantially parallel to the gate line.

The color filter layer may include a red color filter, a green color filter, and a blue color filter corresponding to a pixel area.

The first support pattern portion may connect respective ones of the red color filters, the green color filters, and the blue color filters respectively disposed in different pixel areas to one another.

The first support pattern portion may extend from an end portion of one of the red color filter, the green color filter, and the blue color filter.

The first support pattern portion may extend from another end portion of one of the red color filter, the green color filter, and the blue color filter.

The first support pattern portion may contact the red color filter, the green color filter, and the blue color filter.

The first support pattern portion may include a material the same as a material forming one of the red color filter, the green color filter, and the blue color filter.

The first support unit may include a plurality of layers.

The plurality of layers may be stacked in order of forming the red color filter, the green color filter, and the blue color filter.

A thickness of each layer of the plurality of layers may be thinner than a thickness of the color filter layer.

A ratio of the thickness of each layer of the plurality of layers to the thickness of the color filter layer may be about 1:3.

The color filter layer may further include a second support pattern portion intersecting the first support pattern portion.

The second support pattern portion may connect respective ones of the red color filters, the green color filters, and the blue color filters respectively disposed in different pixel areas to one another.

The second support pattern portion may include a material the same as a material forming one of the red color filter, the green color filter, and the blue color filter.

The second support pattern portion may include a plurality of layers.

A thickness of each layer of the plurality of layers may be thinner than a thickness of the color filter layer.

The display device may further include: a second substrate opposing the first substrate; a liquid crystal layer between the first substrate and the second substrate; a protection layer on the color filter layer; a light shielding layer on the protection layer or the second substrate, the light shielding layer defining a pixel area; and a pixel electrode on the protection layer, the pixel electrode connected to the transistor.

The pixel electrode may include a first sub-pixel electrode and a second sub-pixel electrode in the pixel area, and the transistor may include: a first transistor connected to the gate line, the data line, and the first sub-pixel electrode; and a second transistor connected to the gate line, the data line, and the second sub-pixel electrode.

The first sub-pixel electrode may be spaced apart from the second sub-pixel electrode, having the gate line interposed therebetween.

The foregoing is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and aspects of the present disclosure of invention will be more clearly understood from the following detailed description taken in conjunction with the accompanying drawings, in which:

FIG. 1 is a plan view illustrating a display device according to one exemplary embodiment;

FIG. 2 is a cross-sectional view taken along line I-I′ of FIG. 1;

FIG. 3 is a plan view illustrating a color filter layer of FIG. 2;

FIG. 4 is a disposition view illustrating a red color filter of FIG. 3;

FIG. 5 is a view illustrating a first support pattern portion of FIG. 3 according to another exemplary embodiment;

FIG. 6 is a view illustrating a color filter layer of FIG. 3 according to another exemplary embodiment;

FIG. 7 is a view illustrating a second support pattern portion of FIG. 6 according to another exemplary embodiment; and

FIG. 8 is a plan view illustrating a display device according to another exemplary embodiment.

### DETAILED DESCRIPTION

Hereinafter, embodiments of the present disclosure of invention will be described in more detail with reference to the accompanying drawings. Although the present invention can be modified in various manners and have several embodiments, specific embodiments are illustrated in the accompanying drawings and will be mainly described in the specification. However, the scope of the embodiments of the present invention is not limited to the specific embodiments and should be construed as including all the changes, equivalents, and substitutions included in the spirit and scope of the present invention.

In the drawings, certain elements or shapes may be simplified or exaggerated to better illustrate the present invention, and other elements present in an actual product may also be omitted. Like reference numerals refer to like elements throughout the specification. Thus, the drawings are intended to facilitate the understanding of the present invention.

In addition, when a layer or element is referred to as being “on” another layer or element, the layer or element may be directly on the other layer or element, or one or more intervening layers or elements may be interposed therebetween.

Throughout the specification, when an element is referred to as being “connected” to another element, the element is “directly connected” to the other element, or “electrically connected” to the other element with one or more intervening elements interposed therebetween. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” can be termed likewise without departing from the teachings herein.

Some of the parts which are not associated with the description may not be provided in order to specifically describe embodiments of the present invention, and like reference numerals refer to like elements throughout the specification.

Hereinafter, a display device 10 according to one exemplary embodiment will be described with reference to the accompanying drawing.

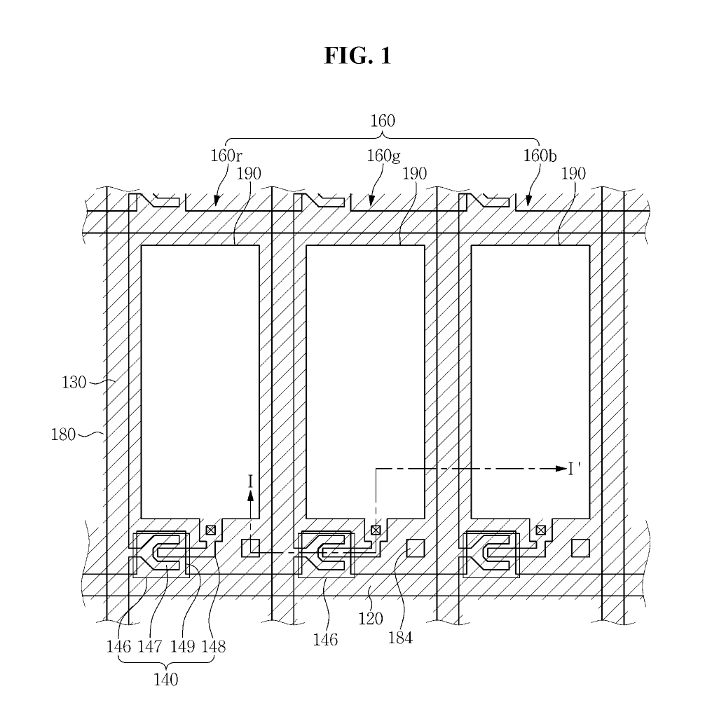

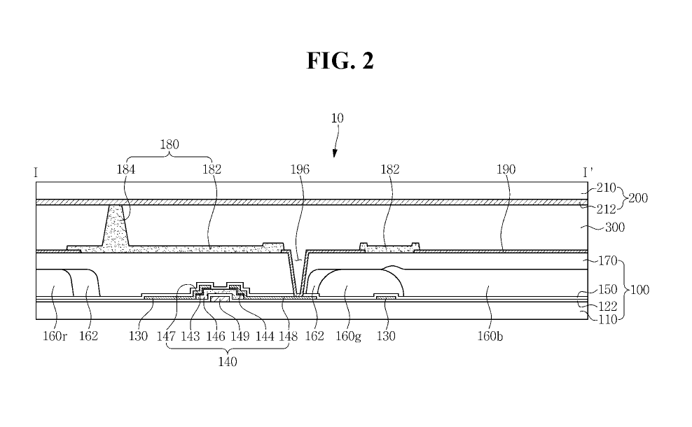

FIG. 1 is a plan view illustrating a display device 10 according to one exemplary embodiment, and FIG. 2 is a cross-sectional view taken along line I-I′ of FIG. 1.

In reference to FIGS. 1 and 2, the display device 10 according to the exemplary embodiment includes a lower panel 100, an upper panel 200 opposing the lower substrate 100, and a liquid crystal layer 300 interposed between the lower panel 100 and the upper panel 200.

The lower panel 100 includes a first substrate 110, a gate line 120 and a data line 130 on the first substrate 110, a transistor 140 connected to the gate line 120 and the data line 130, an insulating layer 150 on the transistor 140 and the data line 130, and a color filter layer 160 on the insulating layer 150.

Further, the lower panel 100 may further include a protection layer 170 on the color filter layer 160, and a light shielding unit 180 and a pixel electrode 190 on the protection layer 170.

The first substrate 110 is an insulating substrate formed of transparent glass such as soda lime glass or borosilicate glass, plastic, or the like.

The gate line 120 is disposed on the first substrate 110 to transmit a gate signal. The gate line 120 extends in a direction, for example, in a transverse direction. Meanwhile, the gate line 120 is connected to the transistor 140 which is to be further described below. Herein, a gate electrode 149 may be formed to protrude from the gate line 120 so as to be connected to the transistor 140.

The gate line 120 may be formed of an aluminum (Al) based metal such as Al or an Al alloy, a silver (Ag) based metal such as Ag or an Ag alloy, a copper (Cu) based metal such as Cu or a Cu alloy, a molybdenum (Mo) based metal such as Mo or a Mo alloy, chromium (Cr), titanium (Ti), tantalum (Ta), or the like.

In addition, the gate line 120 may have a multilayer structure including two conductive layers (not illustrated) having different physical properties.

For example, one of the two conductive layers may include a metal having low resistivity so as to reduce signal delay or a voltage drop, for example, an aluminum (Al)-based metal, a silver (Ag)-based metal, a copper (Cu)-based metal, or the like.

On the other hand, the other of the two conductive layers may include a material that is found to impart an excellent contact property with transparent conductive oxide (TCO), for example, indium tin oxide (ITO), indium zinc oxide (IZO), or aluminum zinc oxide (AZO). Examples of such a material may include a molybdenum-based metal, chromium, titanium, tantalum, and the like.

The data line 130 is disposed in a direction intersecting the gate line 122, for example, a longitudinal direction. The data line 130 is connected to the transistor 140 to be described further below. Herein, the data line 130 is connected to the transistor 140 through a source electrode 147 to be described further below. The data line 130 transmits a data signal voltage to the pixel electrode, to be described below, through the transistor 140.

Meanwhile, a gate insulating layer 122 is disposed between the gate line 120 and the data line 130. The gate insulating layer 122 is formed over an entire surface of the first substrate 110 so as to cover and insulate the gate line 120. The gate insulating layer 122 may be formed of silicon oxide (SiOₓ), silicon nitride (SiNₓ), or the like. In addition, the gate insulating layer 122 may have a multilayer structure including two insulating layers (not illustrated) having different physical properties.

The gate insulating layer 122 may prevent a short circuit of the gate lines 120. Further, the gate insulating layer 122 may serve to insulate the gate line 120 from other conductive thin films disposed above the gate line 120.

The transistor 140 is on the gate insulating layer 122. In detail, the transistor 140 includes a semiconductor layer 146 on the gate insulating layer 122 and is connected to the gate line 120, the data line 130, and the pixel electrode 190 to be described below.

In general, the transistor 140 includes a source electrode 147, a semiconductor layer 146, a drain electrode 148, and a gate electrode 149. The source electrode 147 connects the transistor 140 and the data line 130. Further, the drain electrode 148 connects the transistor 140 and the pixel electrode 190 to be described below.

The source electrode 147 may be formed to protrude from the data line 130, and the drain electrode 148 may be connected to the pixel electrode 190 through a contact hole 196 to be described below. The gate electrode 149 may be formed to protrude from the gate line 120 in the above-described manner. Further, the gate electrode 149 is disposed to overlap the semiconductor layer 146 from therebelow. Herein, the semiconductor layer 146 forms a channel through which current may flow.

Meanwhile, ohmic contact layers 143 and 144 are disposed on the semiconductor layer 146. The ohmic contact layers 143 and 144 are configured to improve a contact property between the semiconductor layer 146 and the source electrode 147 and/or the drain electrode 148.

For example, the ohmic contact layers 143 and 144 may include amorphous silicon doped with n-type impurities at high concentration (hereinafter, “n+a-Si”). In a case in which the contact property between the semiconductor layer 146 and the source electrode 147 and/or the drain electrode 148 is sufficiently secured, the ohmic contact layers 143 and 144 may be omitted in the present exemplary embodiment.

The insulating layer 150 is disposed on the transistor 140, the data line 130, and the gate insulating layer 122. The insulating layer 150 may have a monolayer structure or a multilayer structure including, for example, silicon oxide, silicon nitride, a photosensitive organic material, or a low dielectric constant insulating material such as a-Si:C:O or a-Si:O:F.

The insulating layer 150 is configured to cover the transistor 140, the data line 130, and the gate insulating layer 122 to prevent detachment thereof, and insulate the transistor 140, the data line 130, and the gate insulating layer 122 from other conductive materials disposed above the insulating layer 150.

The color filter layer 160 is disposed on the insulating layer 150. In particular, the color filter layer 160 may be disposed corresponding to a pixel area defined by the light shielding unit 180 to be described below.

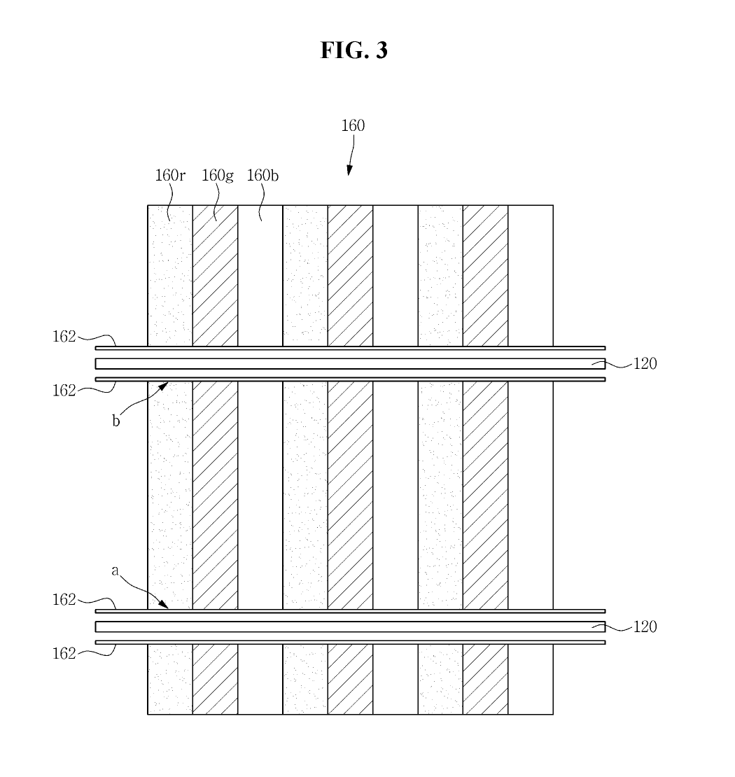

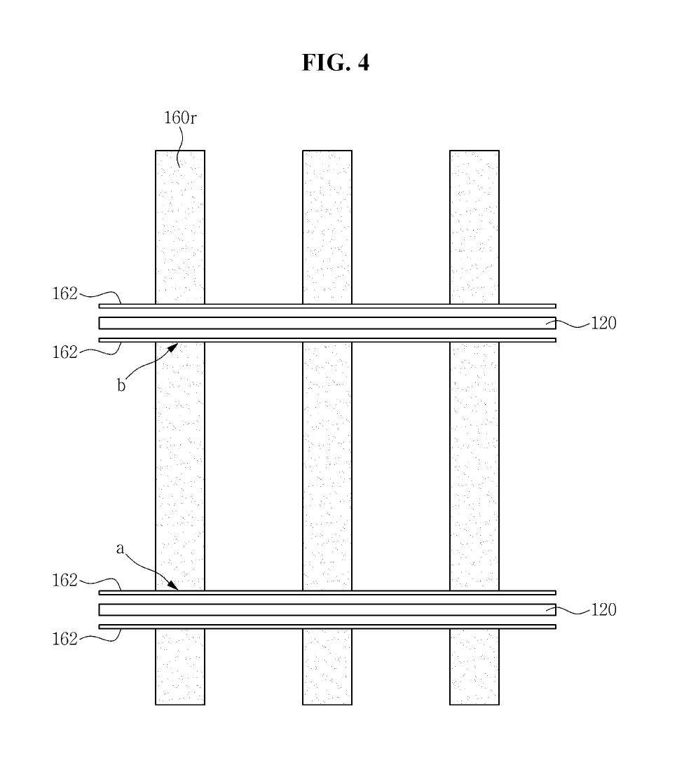

FIG. 3 is a plan view illustrating the color filter layer 160 of FIG. 2; and FIG. 4 is a disposition view illustrating a red color filter 160r of FIG. 3.

In reference to FIGS. 3 and 4, the color filter layer 160 may include the red color filter 160r, a green color filter 160g, a blue color filter 160b, and a first support pattern portion 162. Herein, the red color filter 160r, the green color filter 160g, and the blue color filter 160b are disposed to correspond to the pixel area. Accordingly, the red color filter forms a red pixel area, the green color filter 160g forms a green pixel area, and the blue color filter 160b forms a blue pixel area.

Meanwhile, the red color filter 160r, the green color filter 160g, and the blue color filter 160b are sequentially disposed in a direction, for example, a transverse direction. Accordingly, the color filter layer 160 may be formed on the insulating layer 150 to extend in a direction.

Further, color filters of at least one of the red color filter 160r, the green color filter 160g, and the blue color filter 160b are spaced apart from one another, having the gate line 120 interposed therebetween.

For example, the red color filters 160r may be spaced apart from one another with the gate line 120 interposed therebetween. Further, the red color filter 160r, the green color filter 160g, and the blue color filter 160b between the gate lines 120 may be disposed to overlap one another at an edge portion thereof.

The color filter layer 160 may further include a color filter representing another color, in addition to the red color filter 160r, the green color filter 160g, and the blue color filter 160b. For example, the color filter layer 160 may further include a white color filter (not illustrated).

The color filter layer 160 may have a thickness in a range of about 2 μm to about 4 μm. However, the thickness of the color filter layer 160 is not limited to the range.

The first support pattern portion 162, when viewed from a plan view, is disposed on one end portion of the color filter layer 160 and disposed substantially parallel to the gate line 120. In detail, the first support pattern portion 162 extends from an end portion of one of the red color filter 160r, the green color filter 160g, and the blue color filter 160b, along the gate line 120.

In reference to FIG. 4, the red color filter 160r is disposed on the insulating layer 150, corresponding to the pixel area. Further, the first support pattern portion 162 is disposed on one end portion “a” and another end portion “b” of the red color filter 160r. That is, the first support pattern portion 162 connects the red color filters 160r in different pixel regions. In an alternative exemplary embodiments, the first support pattern portion 162 may be disposed on at least one of the one end portion “a” and the another end portion “b.” Herein, the first support pattern portion 162 is formed of the same material as that forming the red color filter 160r.

As an example, the color filter layer 160 may be formed in order of the red color filter 160r, the green color filter 160g, and the blue color filter 160b.

FIG. 4 illustrates an exemplar embodiment in which the red color filter 160r is firstly formed. A red color filter layer is disposed on the insulating layer 150 to cover an entire surface thereof. Subsequently, a mask having a pattern corresponding to the red color filter 160r and the first support pattern portion 162 is disposed, and light exposure and development are performed. When the light exposure and development are completed, the red color filter 160r and the first support pattern portion 162 are formed on the insulating layer 150.

Meanwhile, so as to form the color filter layer 160 using the mask, the color filter layer 160 may include a photosensitive resin composition. That is, the red color filter 160r, the green color filter 160g, and the blue color filter 160b may be a photoresist respectively including a photosensitive resin composition.

In such a manner, the first support pattern portion 162 may connect respective ones of the red color filters 160r, the green color filters 160g, and the blue color filters 160b respectively disposed in different pixel areas. In this case, the first support pattern portion 162 may be formed of a material the same as a material forming the color filters of the respective ones that are connected to each other.

As described hereinabove, the first support pattern portion 162 supports the color filters in different pixel areas to be connected to each other. Accordingly, in a process of light exposure and development for forming the respective color filters 160r, 160g, and 160b, an edge portion of the respective color filters 160r, 160g, and 160b may be prevented from being partially loosened off and detached.

Further, two first support pattern portions 162 adjacent to each other, among the plurality of first support pattern portions 162, are spaced apart from each other, having the gate line 120 interposed therebetween. Accordingly, when forming the contact hole 196 to be described below, it is unnecessary to pass through the color filter layer 160. Accordingly, the size of the contact hole 196 may be reduced, and thereby the non-display area may be effectively reduced.

Meanwhile, when the red color filter 160r, the green color filter 160g, and the blue color filter 160b are sequentially formed, the first support pattern portion 162 may contact each of the red color filter 160r, the green color filter 160g, and the blue color filter 160b.

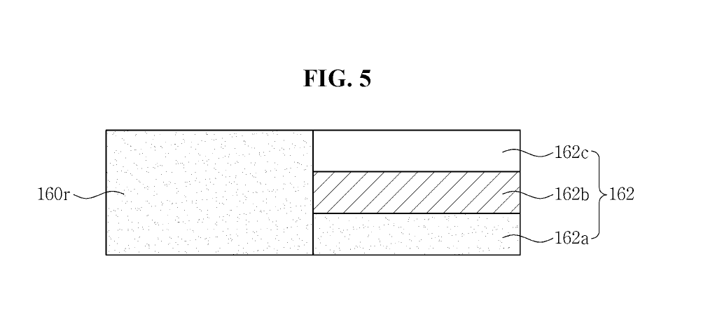

FIG. 5 is a view illustrating a first support pattern portion 162 of FIG. 3 according to another exemplary embodiment.

In reference to FIG. 5, the first support pattern portion 162 may have a plurality of layers. For example, the plurality of layers may include, from below to above, a first layer 162a, a second layer 162b, and a third layer 162c. Herein, the first layer 162, the second layer 162b, and the third layer 162c may be stacked in order of forming the color filter layer 160.

For example, when forming the color filter layer 160, the red color filter 160r, the green color filter 160g, and the blue color filter 160b may be sequentially formed. In this case, the first layer 162a is formed simultaneously with the red color filter 160r, the second layer 162b is formed simultaneously with the green color filter 160g, and the third layer 162c is formed simultaneously with the blue color filter 160b.

Accordingly, the first layer 162a is formed of a material the same as a material forming the red color filter 160r, the second layer 162b is formed of a material the same as a material forming the green color filter 160g, and the third layer 162c is formed of a material the same as a material forming the blue color filter 160b.

Meanwhile, a thickness of the first, second, and third layers 162a, 162b, and 162c constituting the plurality of layers needs to be thinner than the thickness of the color filter layer 160. This is to prevent the first support pattern portion 162 from being thicker than the thickness of the color filter layer 160.

FIG. 5 illustrates one exemplary embodiment in which the first support pattern portion 162 including the first, second, and third layers 162a, 162b, and 162c are stacked to have a thickness the same as the thickness of the red color filter 160r. That is, in a case where the thickness of the first support pattern portion 162 is assumed to be 1, a thickness of each of the first, second, and third layers 162a, 162b, and 162c corresponds to one third of the thickness of the first support pattern portion 162.

The first, second, and third layers 162a, 162b, and 162c may be formed using a half-tone mask or a diffraction exposure mask.

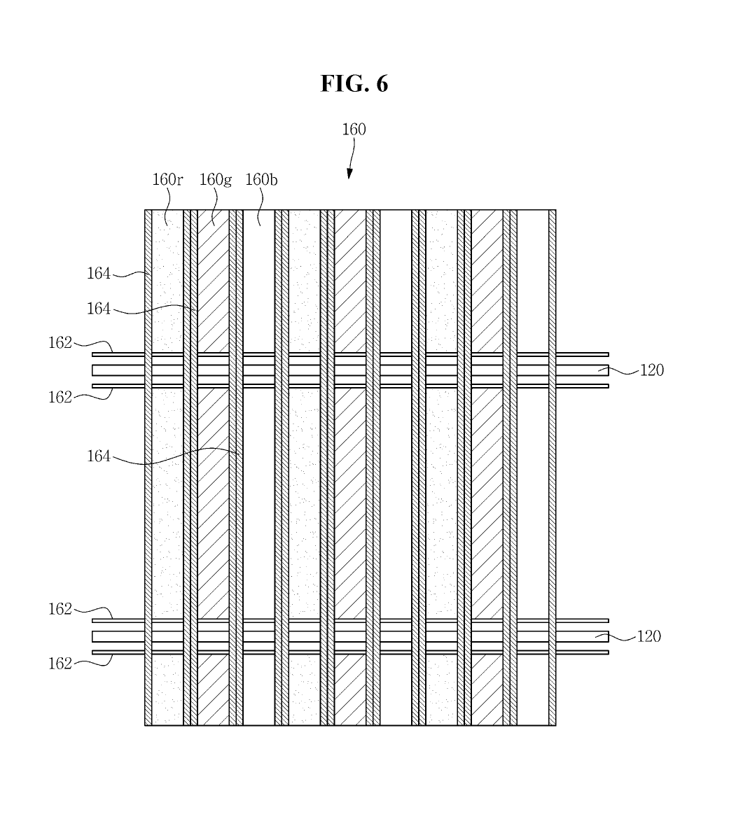

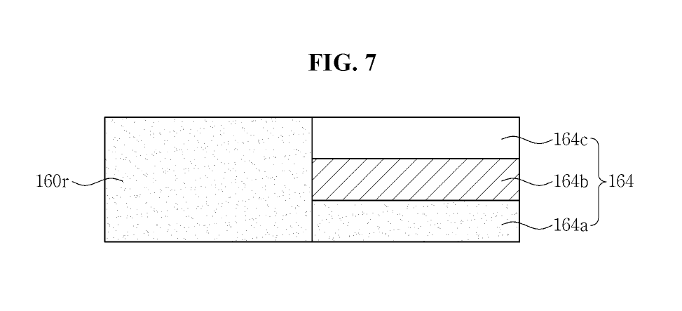

FIG. 6 is a view illustrating a color filter layer 160 of FIG. 3 according to another exemplary embodiment, and FIG. 7 is a view illustrating a second support pattern portion 164 of FIG. 6 according to another exemplary embodiment.

In reference to FIGS. 6 and 7, the color filter layer 160 may further include a second support pattern portion 164. The second support pattern portion 164 is disposed on the insulating layer 150, and intersects the first support pattern portion 162.

In detail, the second support pattern portion 164 is disposed parallel to the data line 130 and connects the color filter layers 160 substantially vertically. That is, the second support pattern portion 164 connects respective ones of the red color filters 160r, the green color filters 160g, and the blue color filters 160b in different pixel areas.

In this case, the second support pattern portion 164 may be formed of a material the same as a material forming the color filters of the respective ones that are connected to each other. For example, in a case where the second support pattern portion 164 connects the red color filters 160r in pixel regions different from one another, the second support pattern portion 164 is formed of a material the same as a material forming the red color filter 160r.

The second support pattern portion 164 may be provided in plural. The plurality of second support pattern portions 164 are disposed at an edge portion of the red color filter 160r, the green color filter 160g, and the blue color filter 160b. Accordingly, two second support pattern portions 164 may be disposed among the respective color filters 160r, 160g, and 160b. On the other hand, in an alternative exemplary embodiment, a single second support pattern portion 164, which is formed integrally, may be disposed among the respective color filters 160r, 160g, and 160b.

In reference to FIG. 7, the second support pattern portion 164 may include a plurality of layers 164a, 164b, and 164c. The second support pattern portion 164 including the plurality of layers 164a, 164b, and 164c may be stacked to have a thickness the same as the thickness of the red color filter 160r. That is, in a case where the thickness of the second support pattern portion 164 is assumed to be 1, a thickness of each of the first, second, and third layers 164a, 164b, and 164c corresponds to one third of the thickness of the second support pattern portion 164.

The present exemplary embodiment with regard to the second support pattern portion 164 including the plurality of layers 164a, 164b, and 164c is the same as the exemplary embodiment with regard to the first support pattern portion 162 described with reference to FIG. 5, and thus the detailed description will be omitted.

The protection layer 170 is disposed on the color filter layer 160. The protection layer 170 may have a monolayer or multilayer structure including, for example, silicon oxide, silicon nitride, a photosensitive organic material, or a low dielectric constant insulating material such as a-Si:C:O and a-Si:O:F.

According to one exemplary embodiment, the protection layer 170 may be formed of a first photosensitive composition which is a positive type where a portion exposed to light is developed. In a case where the protection layer 170 is formed of a photosensitive organic composition, the protection layer 170 is also referred to as an organic layer.

Further, the protection layer 170 is disposed above the color filter layer 160, and may planarize the pixel area and a non-pixel area. Accordingly, the protection layer 170 is also referred to as a planarization layer.

The light shielding unit 180 is disposed on the protection layer 170. The light shielding unit 180 prevents light provided from a backlight unit (not illustrated) from being dissipated outwards, and prevents light incident from outside of the display device 10 from being irradiated to the gate line 120, the data line 130, and the transistor 140.

The light shielding unit 180 includes a light shielding layer 182 and a column spacer 184 protruding from the light shielding layer 182.

The light shielding layer 182 is also referred to as a black matrix. The light shielding layer 182 divides the plurality of color filters 160r, 160g, and 160b from each other, defines the pixel area, and prevents light leakage. The light shielding layer 182 may have a lattice structure disposed along the gate line 120 and the data line 130. Further, the light shielding layer 182 may overlap the gate line 120, the data line 130, and the transistor 140.

The column spacer 184 has a structure protruding from the light shielding layer 182. That is, a protruding portion of the light shielding layer 182 corresponds to the column spacer 184. The column spacer 184 maintains a uniform interval between the lower panel 100 and the upper panel 200, and thereby improves an overall operational property of the display device 10.

In detail, an interval between the lower panel 100 and the upper panel 200 of the display device 10 is referred to as a cell gap, and the cell gap affects an overall operational property of the display device 10, such as response speed, contrast ratio, a viewing angle, luminance uniformity. Accordingly, in a case where the cell gap is non-uniform, an image may not be uniformly displayed across an entire screen, thus resulting in image quality defects. Accordingly, so as to maintain a uniform cell gap over an entire area of the panel, the plurality of column spacers 184 are disposed on at least one side of the lower panel 100 and the upper panel 200.

Meanwhile, although the light shielding unit 180 is described as being disposed on the protection layer 170 on the first substrate 110, the present invention is not limited thereto. The light shielding unit 180 may be disposed on the second substrate 210 described below.

The pixel electrode 190 electrically connected to the drain electrode 148 through the contact hole 196 is disposed on the protection layer 170. The pixel electrode 190 may be formed of a transparent conductive oxide (TCO), such as indium tin oxide (ITO), indium zinc oxide (IZO), or aluminum zinc oxide (AZO). The pixel electrode 190 is disposed in the pixel region defined by the light shielding layer 182.

The color filter layer 160 according to the present invention is absent on the transistor 140 and the gate line 120. That is, only the protection layer 170 is disposed on the transistor 140 and the gate line 120. Accordingly, the contact hole 196 is only defined in the protection layer 170, such that the size of the contact hole 196 may be reduced. In some embodiments, the color filter layer 160 may partially overlap the transistor 140 or the gate line 120, as long as it does not affect formation of the contact hole 196.

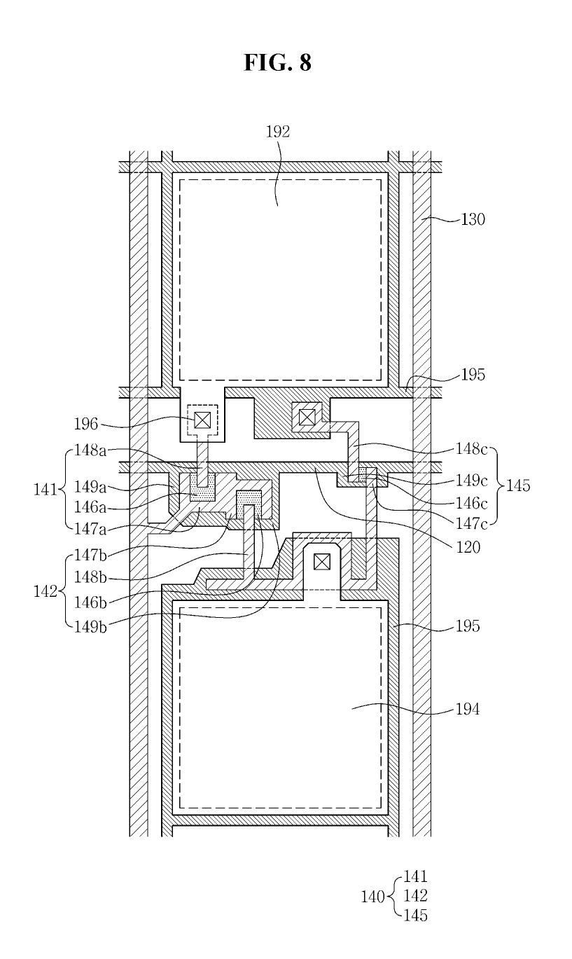

FIG. 8 is a plan view illustrating a display device 10 according to another exemplary embodiment.

In reference to FIG. 8, the pixel electrode 190 may include a first sub-pixel electrode 192 and a second sub-pixel electrode 194. Further, the transistor 140 may include a first transistor 141, a second transistor 142, and a third transistor 145.

The first sub-pixel electrode 192 and the second sub-pixel electrode 194 are disposed in a pixel region. In this case, the first sub-pixel electrode 192 is spaced apart from the second sub-pixel electrode 194 with the gate line 120 interposed therebetween. Meanwhile, a storage line 195 is disposed in a peripheral portion of the first sub-pixel electrode 192 and the second sub-pixel electrode 194. The storage line 195 is connected to a third transistor 145 to be described below, and has a predetermined voltage.

The first transistor 141 includes a first source electrode 147a connected to a data line 130, a first drain electrode 148a connected to the first sub-pixel electrode 192, a first semiconductor layer 146a, and a first gate electrode 149a connected to a gate line 120.

The second transistor 142 includes a second source electrode 147b connected to the data line 130, a second drain electrode 148b connected to the second sub-pixel electrode 194, a second semiconductor layer 146b, and a second gate electrode 149b connected to the gate line 120.

The third transistor 145 includes a third source electrode 147c connected to the second sub-pixel electrode 194, a third drain electrode 148c connected to the storage line 195, a third gate electrode 149c connected to the gate line 120, and a third semiconductor layer 146c.

The upper panel 200 is disposed to face the lower panel 100. Further, the upper panel 100 may include a second substrate 210 and a common electrode 212.

The second substrate 210 is disposed to oppose the first substrate 110. The second substrate 210 is an insulating substrate formed of transparent glass such as soda lime glass or borosilicate glass, plastic, or the like.

The common electrode 212 may be formed of a transparent conductive oxide (TCO), such as indium tin oxide (ITO), indium zinc oxide (IZO), or aluminum zinc oxide (AZO). Meanwhile, although the common electrode 212 is described as being disposed on the second substrate 210, the present invention is not limited thereto. In alternative embodiments, the common electrode 212 may be disposed on the first substrate 110.

As set forth hereinabove, according to exemplary embodiments, a display device includes a lower substrate and a color filter layer on the lower substrate, and the color filter layer includes a red color filter, a green color filter, a blue color filter, and a first support pattern portion. Herein, the first support pattern portion supports color respective ones of red color filters, green color filters, and blue color filters to be connected to each other. Accordingly, partial detachment of an edge portion of the respective color filter layer may be prevented in a process of light exposure and development performed to form the color filter layer.

From the foregoing, it will be appreciated that various embodiments in accordance with the present disclosure have been described herein for purposes of illustration, and that various modifications may be made without departing from the scope and spirit of the invention. Accordingly, the various exemplary embodiments disclosed herein are not intended to be limiting of the true scope and spirit of the invention. Various features of the above described and other exemplary embodiments can be mixed and matched in any manner, to produce further exemplary embodiments consistent with the invention.

What is claimed is:

1. A display device comprising:
a first substrate;
a gate line and a data line on the first substrate;
a transistor connected to the gate line and the data line;
an insulating layer on the data line and the transistor; and
a color filter layer on the insulating layer,
wherein the color filter layer comprises a first support pattern portion extending substantially parallel to the gate line.

2. The display device of claim 1, wherein the color filter layer comprises a red color filter, a green color filter, and a blue color filter corresponding to a pixel area.

3. The display device of claim 2, wherein the first support pattern portion connects respective ones of the red color filters, the green color filters, and the blue color filters respectively disposed in different pixel areas to one another.

4. The display device of claim 3, wherein the first support pattern portion extends from an end portion of one of the red color filter, the green color filter, and the blue color filter.

5. The display device of claim 4, wherein the first support pattern portion extends from another end portion of one of the red color filter, the green color filter, and the blue color filter.

6. The display device of claim 5, wherein the first support pattern portion contacts the red color filter, the green color filter, and the blue color filter.

7. The display device of claim 5, wherein the first support pattern portion comprises a material the same as a material forming one of the red color filter, the green color filter, and the blue color filter.

8. The display device of claim 5, wherein the first support unit comprises a plurality of layers.

9. The display device of claim 8, wherein the plurality of layers are stacked in order of forming the red color filter, the green color filter, and the blue color filter.

10. The display device of claim 9, wherein a thickness of each layer of the plurality of layers is thinner than a thickness of the color filter layer.

11. The display device of claim 10, wherein a ratio of the thickness of each layer of the plurality of layers to the thickness of the color filter layer is about 1:3.

12. The display device of claim 11, wherein the color filter layer further comprises a second support pattern portion intersecting the first support pattern portion.

13. The display device of claim 12, wherein the second support pattern portion connects respective ones of the red color filters, the green color filters, and the blue color filters respectively disposed in different pixel areas to one another.

14. The display device of claim 13, wherein the second support pattern portion comprises a material the same as a material forming one of the red color filter, the green color filter, and the blue color filter.

15. The display device of claim 13, wherein the second support pattern portion comprises a plurality of layers.

16. The display device of claim 15, wherein a thickness of each layer of the plurality of layers is thinner than a thickness of the color filter layer.

17. The display device of claim 16, further comprising:
a second substrate opposing the first substrate;
a liquid crystal layer between the first substrate and the second substrate
a protection layer on the color filter layer;
a light shielding layer on the protection layer or the second substrate, the light shielding layer defining a pixel area; and
a pixel electrode on the protection layer, the pixel electrode connected to the transistor.

18. The display device of claim 17, wherein the pixel electrode comprises a first sub-pixel electrode and a second sub-pixel electrode in the pixel area, and
the transistor comprises:
a first transistor connected to the gate line, the data line, and the first sub-pixel electrode; and
a second transistor connected to the gate line, the data line, and the second sub-pixel electrode.

19. The display device of claim 18, wherein the first sub-pixel electrode is spaced apart from the second sub-pixel electrode, having the gate line interposed therebetween.
